(19) United States
(12) Patent Application Publication
(10) Pub. No.: US 2002/0067980 A1
(43) Pub. Date: Jun. 6, 2002

(54) COMPONENT FEEDER

(76) Inventors: RICHARD D. HAVICH, BINGHAMTON, NY (US); JOHN ANTHONY KUKOWSKI, JOHNSON CITY, NY (US); KEVIN T. EMMONS, BINGHAMTON, NY (US); CHRISTOPHER MARKS, GUILFORD, NY (US)

Correspondence Address: BURNS DOANE SWECKER & MATHIS L L P, POST OFFICE BOX 1404, ALEXANDRIA, VA, 22313-1404, US

(21) Appl. No.: 09/337,894

(22) Filed: Jun. 21, 1999

(51) Int. Cl. B65G 59/08; B65G 47/78

(52) U.S. Cl. 414/403; 414/413

(57) ABSTRACT

A component feeder for an automatic placement machine holds a number of tubes containing electronic components and feeds them sequentially to a pick point located at the end of a track. A tube in a loading position is pressed into contact with the end of a track. The remaining tubes in the magazine are held by an escapement mechanism. A pusher is driven along the bore of the tube in the loading position to drive component from the tube and along the track to the pick point. When the tube in the loading position is empty, front and rear supports are withdrawn and the tube drops from the bottom of the feeder. The escapement mechanism then lowers a next tube into the loading position.

This invention is directed to a feeder that reliably transports electronic components from a plurality of tubes stored in a tube magazine to the pick point of an automatic placement machine.

Automatic placement machines are commonly used to assemble printed circuit boards. These machines allow a large number of components to be placed at predetermined locations on a printed circuit board accurately. By eliminating the human labor required to assemble or “stuff” printed circuit boards, the cost per board is reduced.

Placement of components in an automatic placement machine is done by a robotic placement head. Under control of a predetermined program, the placement head moves to a pick point where a component is held in a predetermined position and orientation. The placement head grasps the component and places it at a predetermined location on the board. The placement head then repeats the placement operation with a next component.

Components can be provided to the pick point by a component feeder. The feeder moves components from a component magazine to the pick point one-after-another to provide a continuous supply of components to the placement head. Typically, an automatic placement machine will have a number of feeders, each providing a distinct component. The placement head moves among the pick points to grasp each different component as needed.

Components may be provided to the feeders in tubes. This is especially true with regard to components that are used in high volumes. In order to provide for long periods of unattended operation, a number of these tubes are held in a magazine. The feeder loads one tube in a loading position and components are provided from that tube to a track. The components are transported along the track to the pick point. As a component is taken from the pick point by the placement head, components in the tube and along the track are advanced to provide a next component to the pick point When the tube in the loading position is emptied it is ejected from the feeder and the next tube is loaded into the loading position.

To increase the versatility of the feeder, various portions of the feeder are adjustable so that the feeder can accommodate components and tubes with a variety of shapes and dimensions. Such feeders are often referred to as “odd form” feeders. One example of such a feeder is shown in U.S. Pat. No. 4,862,578 (Holcomb). Typically, portions of the magazine are provided with slotted connection holes so that tubes of different lengths and widths can be used. Various parts of the mechanism, such as the track, are customized for each part that will be used in the feeder.

One known method for moving components from the tube in the loading position of a feeder to the track is to provide a stream of air to the tube from a nozzle located at the end of the tube opposite the track. Such a method is described in the above-cited Holcomb patent. The nozzle is supported in a nozzle plate that is affixed to one end of the magazine. The dimensions of the nozzle plate are selected so that the direction of the air stream is along the axis of the tube. The stream of air urges the components toward the track. In order to align the air stream with the axis of the tube a customized nozzle plate is provided for each different tube cross section. The air stream dissipates when it exits the tube and so a feeder using an air stream must provide some means to move components along the track once they exit the tube. Holcomb, for example, uses a vibratory feeder coupled with the track The stroke and direction of the vibrator are selected to cause components to advance along the track.

Another know means for moving components from the tube is a mechanical pusher that applies force to the components. The Model 4902-A Low-Volume Multi-Tube Feeder, manufactured by Universal Instruments Corporation of Binghamton, N.Y., for example, includes such a mechanism. This feeder includes a pusher shaped to pass through the component tube and onto the track. The pusher does not extend along the track, and therefore, like Holcomb, this feeder requires a vibrator to move the components along the track once they have exited the tube.

The tube in Holcomb is positioned between the rear wall of the magazine and a plate with an aperture at the end of the tube nearest the beginning of the track. The aperture is sized to allow the component to pass from the tube onto the track. A customized aperture plate is provided for each different component design and tube cross section used in the feeder.

The use of a aperture is also disclosed in U.S. Pat. No. 5,733,093 (Palm et al.). Palm et al. shows a tube containing components positioned between front and rear stops. A hole is provided in the front stop that is sized to allow components to pass through but to prevent the tube from being displaced. Palm et al. also suggests that the front stop can be customized to provide a specific aperture size for each component used in the feeder.

A problem with using an aperture to prevent movement of the tube is that a gap may be formed between the end of the tube and the beginning of the track. This gap can trap components, causing the feeder to jam. In order to minimize this gap, Holcomb extends the track into the aperture toward the end of the tube. However, variations in tube length, which are the inevitable result of the manufacturing process, can still cause a gap. Typically, tubes vary in length by an eighth of an inch from the longest to the shortest tube. In order to allow the longest possible tube to move smoothly through the magazine, the magazine guides of Holcomb, or the front rear stops of Palm et al., provide clearance for the longest possible tube. When a shorter tube is placed in the loading position the tube cannot span this distance and a gap will result.

Using a vibrator to move components along the track presents a number of problems. Vibrators move components slowly. This increases the time the placement head must wait before a next component is available at the pick point. Vibratory movement is unreliable because it depends on the mass and geometry of the component being moved. In general, low mass components are moved less reliably than more massive components. Also, components with an uneven distribution of mass are moved less effectively than more homogeneous components. In addition, mechanical vibrators add bulk and expense to the feeder.

Once a tube has been emptied of components the feeder must discard the empty tube and replace it with a full tube stored in the magazine. Holcomb describes a method for ejecting an empty tube and loading a next tube. Tubes are stacked one-above-another in a magazine with the bottommost tube being in the loading position. The bottommost tube is supported by a pair of rotatable flippers that are oriented perpendicular to the axis of the tubes. When the bottommost tube is empty the flippers turn parallel to the tubes, allowing the bottommost tube to drop onto a support block. The flippers then turn back to the perpendicular orientation, ejecting the bottommost tube from the side of the feeder. The tube in the magazine above the now-ejected tube drops onto the flippers and is now in the loading position.

One problem with this ejecting mechanism is that the empty tube exits from the side of the feeder. Feeders using this mechanism cannot be positioned directly adjacent one another. A gap must be provided on one side of each feeder to allow empty tubes to exit. This limits the number of feeders that can be accommodated by the automatic placement machine and therefore limits the number of different components that can be stuffed onto a board.

One means for discarding empty tubes that does not require clearance along the side of the feeder is to provide an escapement that drops tubes from the bottom of the feeder. The above-mentioned Universal Model 4902-A feeder provides such an escapement. When this feeder determines that a tube is empty, the pusher is retracted from the tube and supports below the tube are withdrawn by pneumatic cylinders, dropping the tube through a passage at the bottom of the feeder.

In order to determine whether there is a tube in the loading position, and whether there is a next tube in the magazine, sensing means must be provided. Typically, transmissive or reflective optical sensors are used to detect whether a tube is in position. These sensors provide a beam of light that is interrupted or reflected when a tube is present in the magazine or loading area. A detector, positioned to detect the transmitted or reflected beam of light, generates a signal indicating whether a tube is in position. The Universal Model 4902-A feeder, for example, uses reflective sensors to detect whether tubes are in the loading position.

A problem with these types of sensors is that they depend on the optical characteristics of the tube material. In general, tubes are formed from a plastic. This plastic may be transparent, translucent, or opaque, making detection by a transmissive sensor unreliable. The surface of the tubes may have a variety of finishes with different reflective characteristics or may be covered with labels making detection by reflective sensors problematic.

In view of the above-identified problems with known component feeders it is an object of the present invention to provide a feeder that reliably transports parts stored in a tube along a track to a pick point of an automatic placement machine.

It is another object of the invention to provide a mechanism for moving components from a tube onto a track using a mechanical pusher. A mechanical pusher is advantageous over the air stream method disclosed by Holcomb because no separate means for urging the component along the track is required. Such a feeder eliminates the need for a vibrator coupled with the track.

It is another object of the invention to provide a feeder wherein the tube currently being used to supply components is displaced toward the track and is pressed into direct contact with the end of the track, fixing the position of the tube within the feeder. Such a feeder does not require an aperture plate and eliminates any gaps caused by variations in the length of the tube. Prior art devices, for example Holcomb, Palm et al., and the Universal Model 4902-A feeder, lack a mechanism to press the tube in the loading position against the end of the track.

It is another object of the invention to provide a method for supplying components from a tube to a track of a component feeder wherein multiple tubes are stacked in a one-above-another arrangement within a magazine and a bottommost tube is displaced along its longitudinal axis from the magazine toward the track and is pressed into direct contact with the end of the track.

It is another object of the invention to provide a feeder that senses the presence of a tube in the loading position and in the magazine mechanically, without the use of optical sensors. By using a mechanical sensing means, such a feeder reliably detects whether a tube is in position regardless of the optical characteristics of the tube material.

Broadly, a feeder according the invention includes a tube magazine for holding a number of tubes storing components stacked one-above-another. The sides and ends of the magazine are adjustable to accommodate tubes of varying dimensions. An escapement mechanism is provided to hold the tubes within the magazine. This escapement mechanism works in conjunction with a mechanism to support a bottommost tube in a loading position below the magazine. When a full tube is moved from the magazine to the loading position, a tube driving mechanism drives the tube along its longitudinal axis, beyond the front end of the magazine, and into contact with the end of a component transporting track. A pusher is provided along the axis of the tube to drive components from the tube along the track to the pick point. When the tube in the loading position is empty the pusher is retracted, the escapement mechanism releases the empty tube, allowing it to fall from the bottom of the feeder, and the next tube in the magazine is dropped into the loading position.

Further features and advantages of the invention will be apparent upon consideration of the following detailed description of the present invention taken in conjunction with the following drawings, in which like reference characters refer to like parts, and in which:

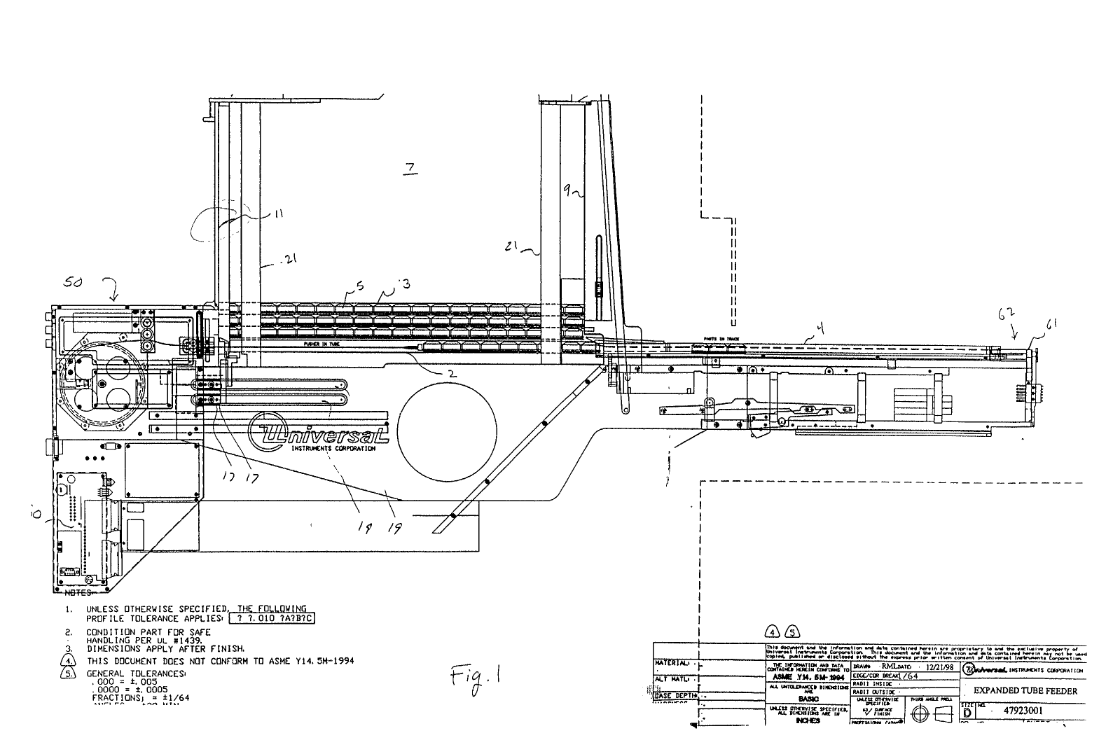

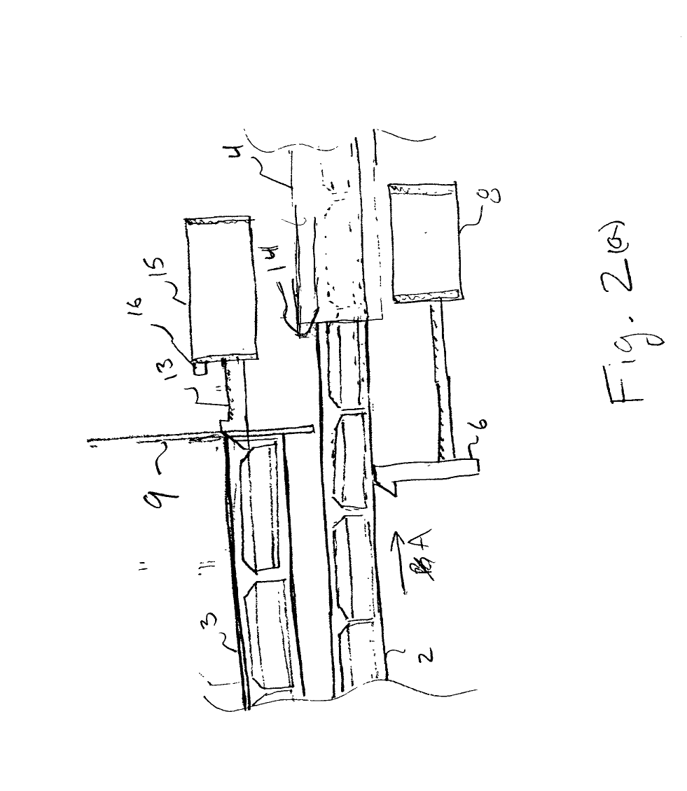

FIG. 1 shows a component feeder according to an embodiment of the present invention;

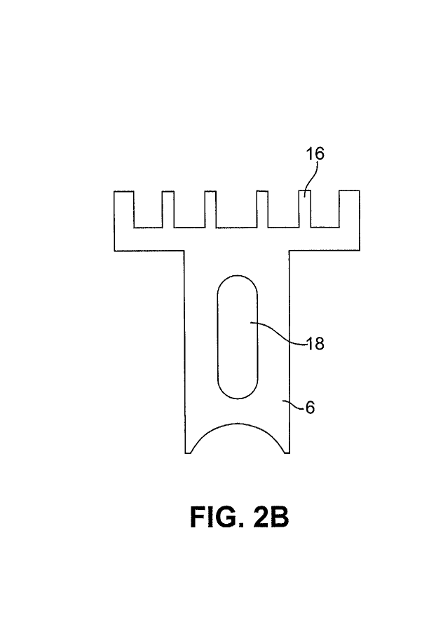

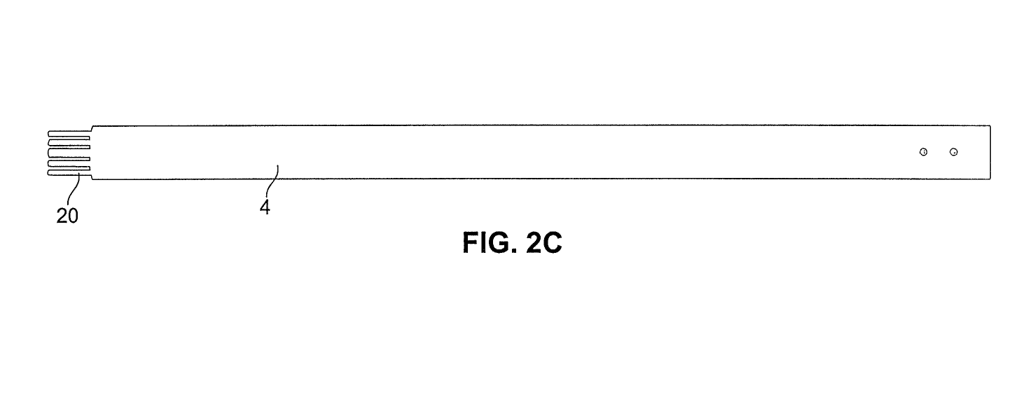

FIG. 2(a) shows a detailed view of a front engagement mechanism according to the embodiment of FIG. 1;

FIG. 2(b) shows an example of a fork for supporting a tube in a loading position to be used in conjunction with the embodiment of FIG. 1;

FIG. 2(c) shows a track used with the fork shown in FIG. 2(b) in conjunction with the embodiment of FIG. 1;

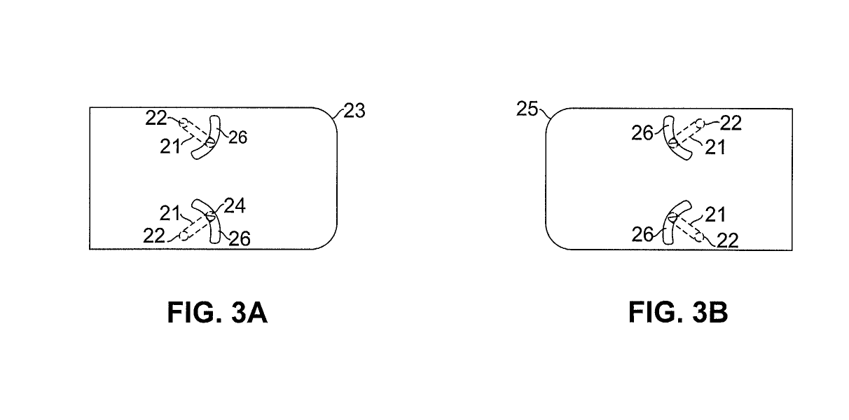

FIGS. 3(a) and 3(b) are top views of top plates according to the embodiment of FIG. 1;

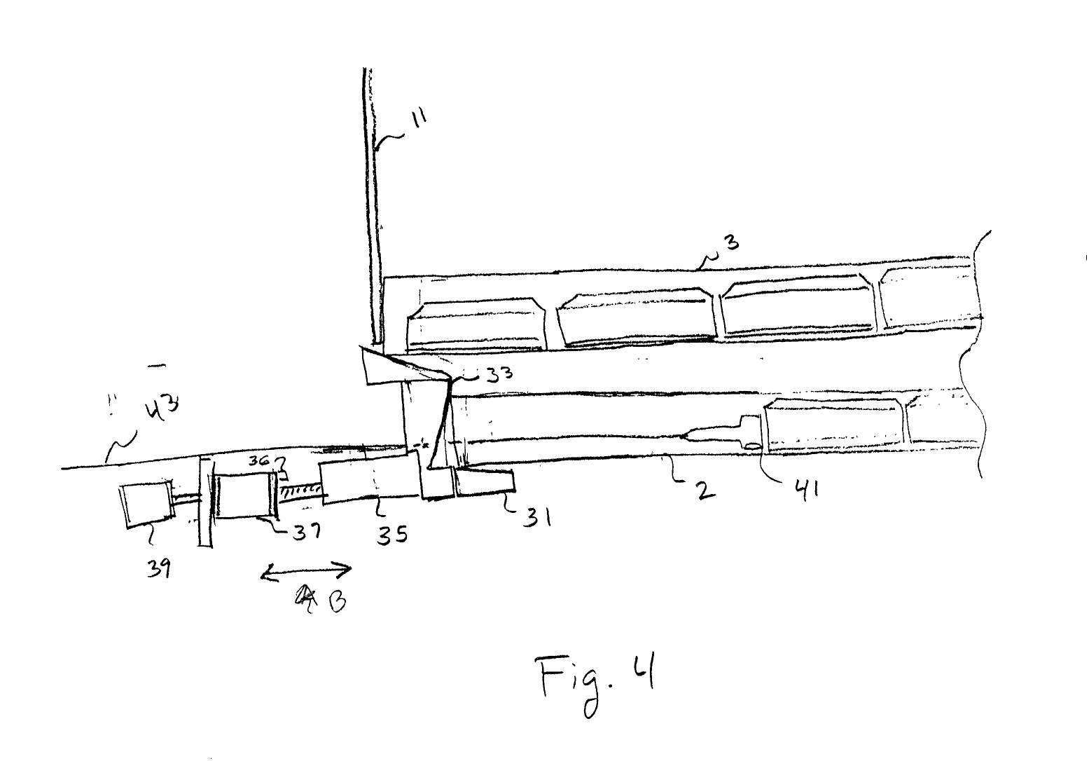

FIG. 4 shows a detailed view of a rear engagement mechanism according to the embodiment of FIG. 1;

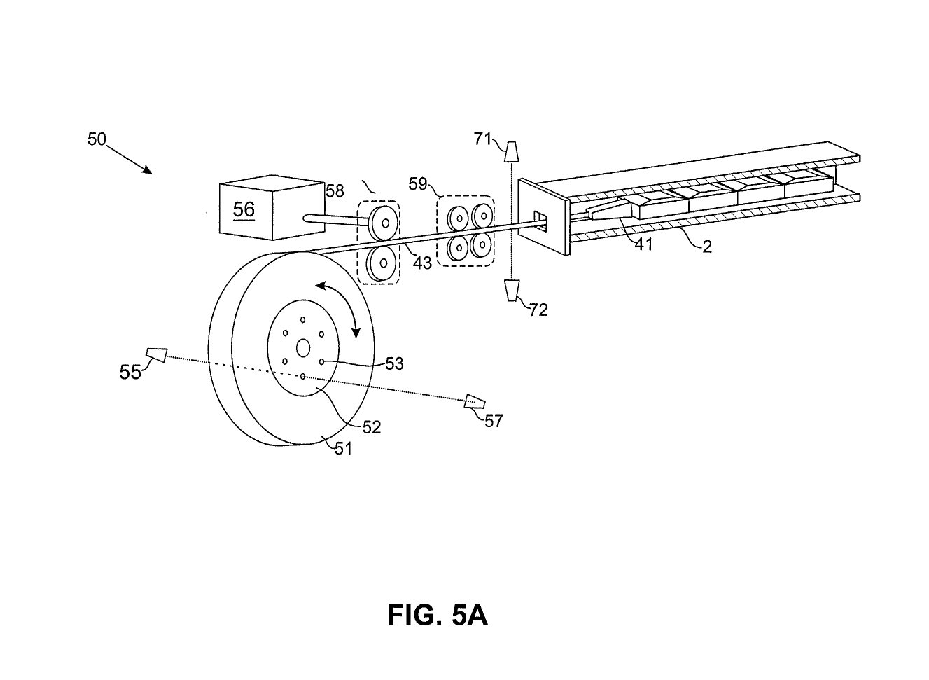

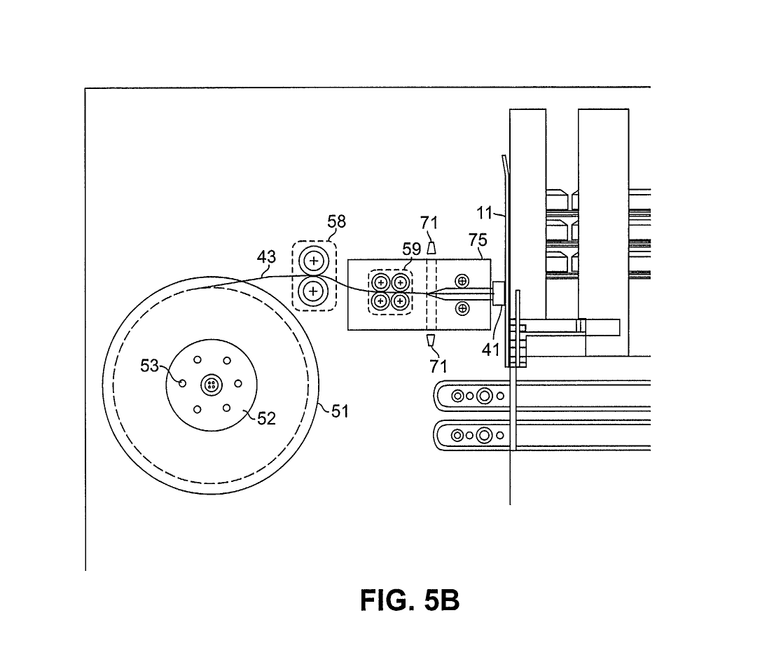

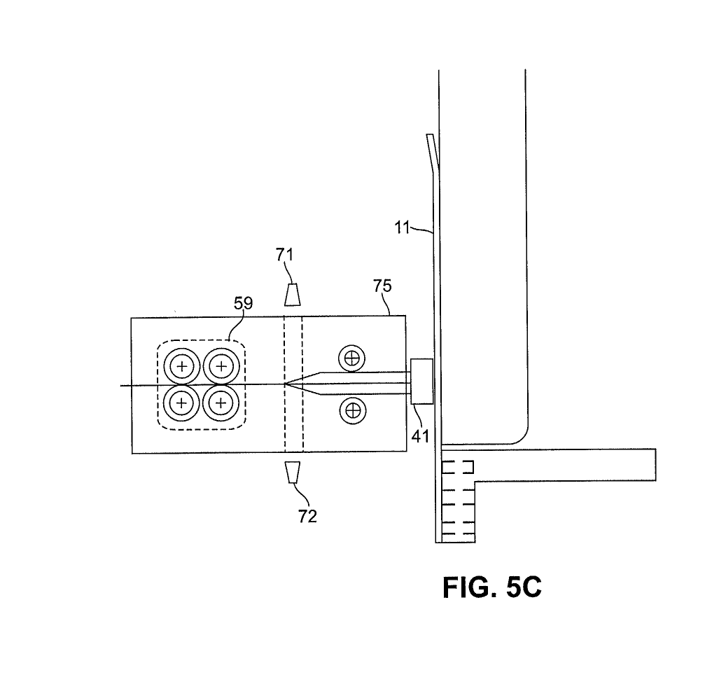

FIGS. 5(a), 5(b), and 5(c) show a pusher drive mechanism according to the embodiment of FIG. 1;

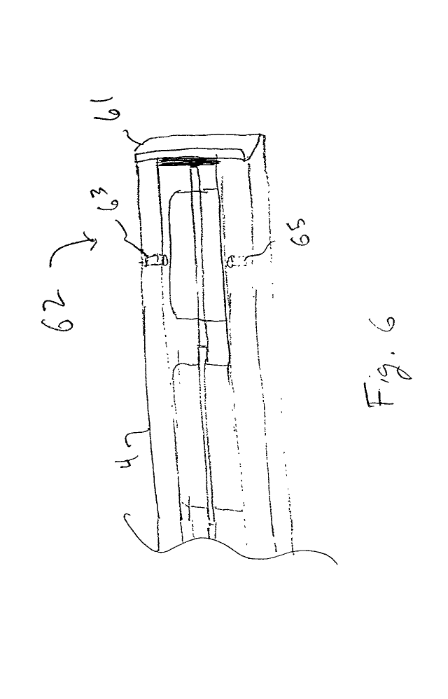

FIG. 6 shows a detailed view of a pick point at the end of a track according to the embodiment of FIG. 1; and

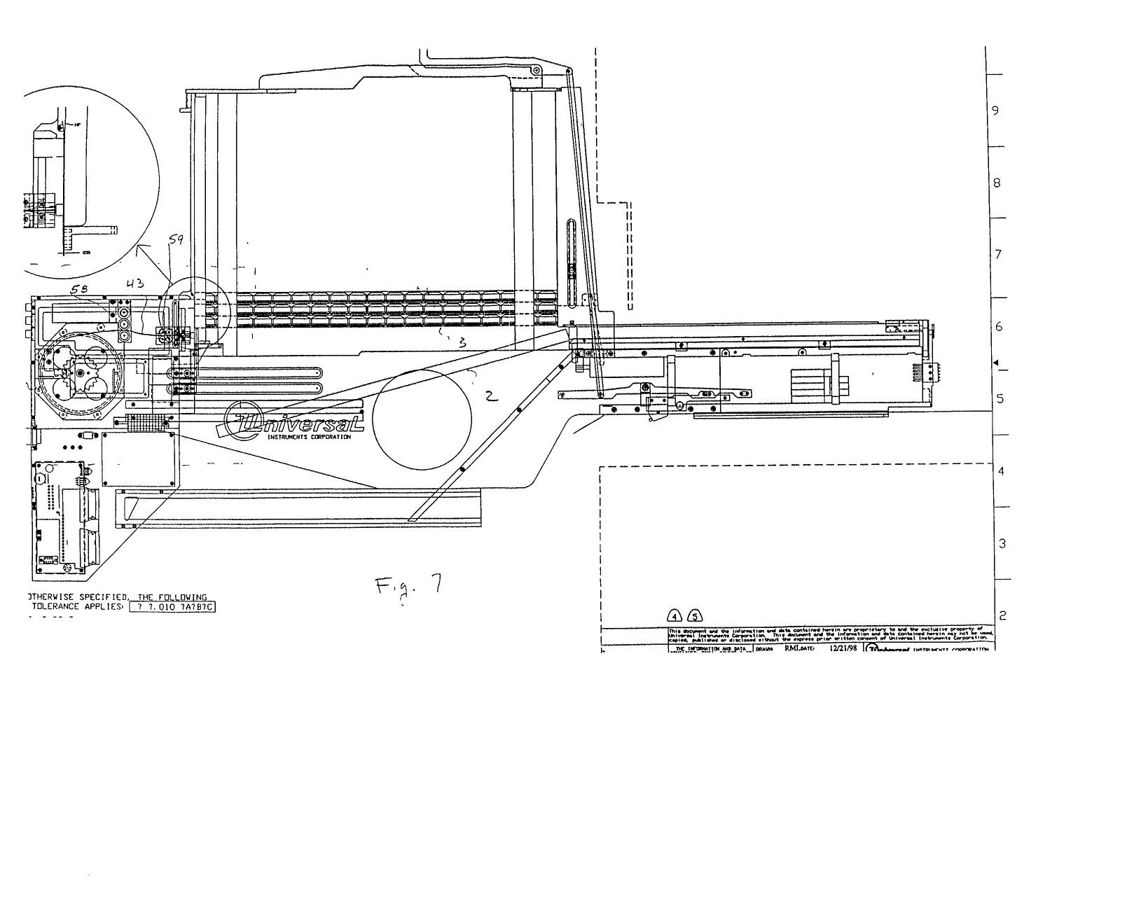

FIG. 7 shows the embodiment of FIG. 1 wherein an empty tube is being dropped by front and rear engagement mechanisms.

FIG. 1 shows feeder 1 according to an embodiment of the invention. A plurality of tubes 3 holding electronic components 5, such as transformers, modular connectors, switches, and the like, are held in a magazine 7 between a front magazine guide 9 and a rear magazine guide 11. The bottommost tube 2 is held in a loading position. As will be discussed below, the tube 2 is urged in the direction shown by Arrow A so that one end of tube 2 is pressed against an end of a component track 4, as shown in FIG. 2(a). A fork 6 supports the bottommost tube 2 near the end of the tube 2 in contact with the end of the track 4. A lip 14 extends from the top of the track 4 above the top surface of the tube 2. The lip 14 includes an angled surface shaped to guide the end of the tube 2 into alignment with the track 4. The height of the fork 6 is adjusted so that the inside bottom surface of tube 2 is coplanar with the inside bottom surface of the track 4. The fork 6 is driven by a pneumatic cylinder 8.

It should be noted that the bottommost tube 2 is not held by the front magazine guide 9, but instead extends longitudinally beyond the front magazine guide 9. Unlike prior art devices that hold a bottommost tube in position behind an aperture, the feeder 1 according to the invention provides direct contact between the end to the bottommost tube 2 and the track 4 by forwardly urging the bottommost tube 2 out of alignment with the remaining tubes 3 and into positive contact with the track 4. Thus, no gap is created between the tube 2 and the track 4 due to variations in the length of the tube 2. This is important because manufacturing tolerances can result in significant variation in tube length.

FIG. 2(b) shows a detailed view of a fork 6 according to one embodiment of the invention. In this embodiment the fork 6 has six tines 16 that form the surface that contacts the bottom of the bottommost tube 2. A slotted hole 18 is provided in the lower portion of the fork 6 to connect the fork 6 with the shaft of cylinder 8. The height of the fork 6 relative to the cylinder 8, and hence the surface of the track 4, is set by the point along the slotted hole 18 where the shaft of cylinder 8 is connected.

FIG. 2(c) shows the underside of the track 4 according to this same embodiment of the invention. The end of the track 4 is provided with slots 20 to accommodate the tines 16 of the fork 6. When the fork 6 is retracted, the tines 16 fit within the slots 20 and the fork 6 is completely withdrawn from beneath the bottommost tube 2. It is to be understood that the number and positions of the tines 16 and slots 20 are given by way of example only. The precise design of these features depends on the configuration of small features extending from the bottom surfaces of components 5 to be handled by the feeder 1. Where a component 5 has, for example, downward pointing leads in two rows along either edge, the track 4 may have three slots 20, each located away from the path where the leads will contact the track 4. This prevents the leads from falling into the slots 20. Such a track 4 would be matched with a fork 6 with three corresponding tines 16.

According to another embodiment of the invention, instead of providing the fork 6 with tines 16 that fit within slots 20 in the track 4, the fork 6 is deflected by a cam as cylinder 8 retracts. The cam causes the fork 6 to be displaced below the level of the end of the track 4. When the fork 6 is fully retracted it is positioned below the end of the track 4.

As shown in FIG. 2(a), the remaining tubes 3 in the magazine 7 are supported at one end by a finger 13. The finger 13 extends through front magazine guide 9 and engages the top inside surface of tube 3. The finger 13 is driven by pneumatic cylinder 15. As will be explained below, when the cylinder 15 retracts the finger 13, tube 3 is allowed to drop onto the fork 6 in preparation for moving tube 3 into the loading position. The pneumatic cylinder 15 is provided with a sensor 16 that detects when the cylinder is fully extended. According to one embodiment of the invention this sensor 16 is a hall-effect sensor that detects a magnetic flag affixed to the shaft of the cylinder 15. Other known means for detecting the position of a shaft can also be used without departing from the scope of the invention. The pneumatic pressure supplied to the cylinder 15 is adjusted so that the cylinder 15 will reach its full extension only if there is no tube 3 in the magazine 7. Thus, a signal that the cylinder 15 has reached its full extension indicates that there is no tube 3 in the magazine 7.

According to one embodiment of the invention, the length of the track 4 is selected to optimize placement of pick points 62 within an automatic placement machine, for example, the GSM Automatic Placement Machine, manufactured by the Universal Instruments Corporation of Binghamton, N.Y. (not shown). According to this embodiment, a plurality of feeders 1, each providing a different component 5, are arranged along the sides of a placement machine with the magazines 7 projecting outward and the pick points 62 arranged along either side of a conveyor (not shown) within the placement machine. The width of the conveyor is adjusted to accommodate a printed circuit board (not shown) that is to be stuffed. When the printed circuit board is relatively narrow, for example less than twelve inches across, longer tracks 4 are provided to feeders 1 along at least one side of the placement machine to position pick points 62 nearby the board. When a wider board is processed the feeders 1 are provided with shorter tracks 4 to accommodate the width of the board.

As shown in FIG. 1, the tubes 3 that are not in the loading position occupied by the bottommost tube 2 are positioned between a front magazine guide 9 and a rear magazine guide 11. The distance between the guides 9, 11 can be adjusted by loosening fasteners 17 secured in slotted holes 19 and sliding the rear magazine guide 11 relative to the front magazine guide 9.

Rotatable vanes 21 are provided on either side of the magazine 7 to adjust for different tube widths and to align the tubes 2,3 with the track 4. As shown in FIGS. 3(a) and 3(b), the vanes 21 are connected with front top plate 25 and rear top plate 23 by a rotatable pin 22 on the vane 21 extending through a hole in the top plate 23, 25. A curvilinear slot 26 is provided in each plate 23, 25 above each vane 21. A screw 24 extends through the curvilinear slot 26 and into the top of the vane 21. Tightening the screw 24 locks the position of the vane 21 relative to the top plate 23, 25 so that the separation between the edges of the vanes 21 can be adjusted.

FIG. 4 is a detailed view of the engagement of the rear ends of the tubes 2, 3 by the feeder 1. Bottommost tube 2 is supported by a tube catch plate 31. The tube catch plate 31 is connected with a tube support 33 by a removable fastener such as one or more bolts (not shown). The tube support 33 is connected with a rear drive plate 35. The rear drive plate 35 is driven in the directions shown by Arrow B by a tube drive cylinder 37 and a rear engagement cylinder 39. With both cylinders 37, 39 extended the tube catch plate 31 supports the rear end of the bottommost tube 2 while the tube support 33 supports tube 3 in the magazine 7. The tube drive cylinder 37 is provided with a sensor 36 that detects when the tube drive cylinder 37 is fully extended. Cylinder 37 will reach its full extension only if there is no tube 2 in the bottommost position. As with the finger drive cylinder sensor 16, described with respect to FIG. 2(a), the sensor 36 on the tube drive cylinder 37 detects the presence of a tube 2 in the loading position more reliably than an optical sensor because it does not depend of the optical characteristics of the tube 2.

Note that when the finger 13 and the tube support 33 are engaged with the tube 3, the tube 3 is lifted above the bottommost tube 2. Lifting tube 3 from tube 2 prevents the weight of the components 5 in the magazine 7 from deflecting the bottommost tube 2.

The tube drive cylinder 37 and rear engagement cylinder 39 act together to drive the tube 2 into contact with the track 4. When a tube 2 is first loaded from the magazine 7 it rests on the fork 6 and tube catch plate 31 with the tube drive cylinder 37 retracted and rear engagement cylinder 39 extended. Next, the tube drive cylinder 37 is extended, pushing the tube 2 along its longitudinal axis and driving the front end of the tube 2 past the front magazine guide 9 and into contact with the track 4. The tube 2 fits below the lip 14 at the top of the track 4. Contact between the tube 2 and the track 4 stops the tube drive cylinder 37. Because the tube drive cylinder 37 is only partially extended, it continues to force tube 2 against the track 4, eliminating any gap.

A pusher 41 is provided to drive components 5 along the tube 2 and along the track 4. The pusher is connected with a drive ribbon 43 to a pusher drive mechanism 50 shown in FIGS. 5(a), 5(b) and 5(c). As shown in FIG. 5(a), ribbon 43 is wound on a spool 51. A radial portion of the spool 51 is opaque and includes a number of transparent regions 53 at predetermined angular positions. A light source 55 directs a beam of light toward the opaque region 52. When one of the transparent regions 53 is aligned with the light source 55 a detector 57 detects the beam of light. The detector 57 sends a pulse to a programmable logic controller (PLC) board 60. The light source 55, the spool 51 and the detector 57 form an encoder that encodes the position of the pusher 41. The PLC board 60 monitors the position of the pusher 41 by keeping track of the number of pulses received from the detector 57. The PLC board 60 controls a ribbon drive motor 56 that rotates drive roller 58 to drive the ribbon 43 forward or backward. As shown in FIGS. 5(a) and 5(b) idler pulleys 58 direct the ribbon 43 so that it extends from the pusher drive mechanism 50 along the axis of the bottommost tube 2. According to one embodiment, the ribbon 43 is made from spring steel. According to a further embodiment the ribbon 43 is made from blue tempered and polished spring steel, Alloy no. 1095, Rockwell temper C48/51 and is available from the McMaster Carr Company of Dayton, N.J. However, other materials, such as stainless steel or polymer composites with suitable resilience and strength, can be used within the scope of the invention. According to another embodiment, a braided wire is used to drive the pusher 41 instead of the ribbon 43.

According to an embodiment of the invention, for a given component design and tube cross section the track 4, fork 6, finger 13, tube support 33, and pusher 41 may be specially constructed. According to this embodiment, when the feeder 1 is set up for a component 5 with a different design from a previous component 5 the track 4, fork 6, finger 13, tube support 33, and pusher 41 may be replaced. The position of slots 20 in the track 4 are selected so that small features of the component 5, such as wire leads, cannot become lodged in the slots 20 as the components 5 are driven from the tube 2 to the track 4. The height of the fork 6 relative to the track 4 and the height of the finger 13 relative to the track 4 are adjusted to accommodate dimensions of the specific tube 2. Also, the height of the tube support 33 relative to the drive block 35 is adjusted so that the tubes 3 in the magazine 7 are supported evenly between the finger 13 and the tube support 33.

As shown in FIG. 5(c), when the pusher 41 is fully retracted by the pusher mechanism 50 it is held within a home block 75. The home block 75 is provided with a light source 71 and detector 72. The light source 71 directs a beam of light through a hole in the home block 75. A hole is provided in the ribbon that aligns with the beam of light when the pusher 41 is in the home block 75 and allows the beam of light to reach the detector 72. When the detector 72 senses the beam of light it sends a signal to the PLC board 60 indicating that the pusher 41 is in its HOME position. According to one embodiment, when the pusher 41 reaches its HOME position the PLC board 60 resets the count of pulses from the spool rotation detector 57.

As shown in FIG. 1, a pick point 62 is located at the end of the track 4. The pick point 62 is defined by an end stop 61. A component 5 is located at the pick point 62 when it is pressed against the end stop 61. FIG. 6 shows the pick point 62 in detail. A light source 63 is provided within one side of the track 4. The light source 63 directs a beam of light across the track 4 at the pick point 62. A detector 65 is located across the track from the light source 63. When no component 5 is positioned at the pick point 62 the beam of light from the light source 63 reaches the detector 65 and a signal is sent to the PLC board 60 indicating that there is presently no component 5 ready at the pick point 62. The PLC board 60 directs the pusher drive motor 56 to advance the pusher ribbon 43, driving the pusher 41 against the components 5 in the bottommost tube 2 and pushing components 5 along the track 4 until the beam of light received by the detector 65 is interrupted. The PLC board 60 stops the ribbon drive motor 56. According to one embodiment of the invention the PLC board 60 then causes the ribbon drive motor 56 to reverse briefly to relieve compression on the components 5 by the ribbon 43.

It should be noted that, by extending the stroke of the pusher 41 beyond the end of tube 2 and along the track 4, components 5 are provided to the pick point 62 without the use of a vibratory feeder. By eliminating the vibratory feeder, used in prior art devices, the feeder 1 according to the invention more reliably feeds components 5 to the pick point 62.

According to one embodiment of the invention, the PLC board 60 is “taught” two positions; a TUBE EMPTY position, indicating that all components 5 within tube 2 have been pushed onto the track 4, and a TRACK EMPTY position, indicating that all components 5 on the track 4 that can be reliably advanced to the pick point 62 have been removed. The PLC board 60 is commanded to control the pusher drive motor 56 to drive the pusher 41 to its HOME position and the count of pulses from the detector 57 is reset. An empty tube 2 is placed in the bottommost position between the rear tube support 33 and the track 4. The PLC board 60 is then commanded to drive the pusher 41 forward until it is at a point forward of the end of the tube 2. The PLC board 60 monitors the number of pulses from the detector 57 and is instructed that this count corresponds to the TUBE EMPTY position. The PLC board 60 is then instructed to drive the pusher 41 forward to a point on the track 4 where no more components 5 can be reliably fed to the pick point 62. This is usually a point about two component lengths from the pick point 62. The PLC board 60 is instructed that the count of pulses to reach this point corresponds to the TRACK EMPTY position.

Operation of the feeder will now be described with reference to FIG. 1 and FIG. 7. FIG. 1 shows a tube 2 in the bottommost position partially full of components 5. Finger 13 is extended to engage the next tube 3 in the magazine 7. The rear engagement cylinder 39 is fully extended so that the tube support 33 supports the bottom surface of tube 3. Tube drive cylinder 37 is partially extended, holding the front end of tube 2 against the end of the track 4. The fork 6 is extended to support the front of tube 2 and the rear of tube 2 rests on the tube catch plate 31. As described above, as components 5 are taken from the pick point 62 the pusher 41 advances through the tube 2.

When the pusher 41 reaches the TUBE EMPTY position the PLC board 60 checks that a tube is positioned in the magazine 7 by inquiring whether the finger drive cylinder 15 is fully extended, as indicated by the sensor 16. If no tube 3 is detected, that is, if sensor 16 detects that cylinder 15 is fully extended, the pusher 41 continues to advance components 5 along the track 4 until it reaches the TRACK EMPTY position. As shown in FIG. 1, tube 3 is present and the PLC board 60 commands the pusher mechanism 50 to retract the pusher 41 to the HOME position. The PLC board 60 commands the tube drive cylinder 37 to retract, pulling the tube catch plate 31 from under the rear of the tube 2. The tube 2 is momentarily caught between the fork 6 and the lip 14 at the top of the track, as shown in FIG. 2(a). The PLC board 60 then commands the fork cylinder 8 to retract. As shown in FIG. 7, the rear end of the tube 2 falls first. The fork 6 continues to retract until the tines 16 of the fork 6 are moved into the slots 20 and the tube 2 is allowed to drop from the bottom of the feeder 1.

The PLC board 60 commands the fork cylinder 8 to extend so that the fork 6 is positioned beneath the front end of tube 3. The PLC board 60 commands the tube support cylinder 39 and finger cylinder 15 to retract, withdrawing the tube support 33 and the finger 13 from beneath the tube 3. The tube 3 falls onto the tube support plate 31 and fork 6.

It should be noted that the empty tube 2 falls through the bottom of the feeder 1. This makes it unnecessary to provide clearance on the side of the feeder 1 to allow empty tubes to eject laterally, as described in prior art devices.

Finger cylinder 15 and tube support cylinder 39 are then extended. The sloped surface of the finger 13 is driven under the top inside surface of the next tube 3 in the magazine 7, lifting it from tube 3 now in the bottommost position. The sloped surface of the tube support 33 is driven under the bottom surface of the next tube 3 in the magazine 7, lifting that tube 3 from the tube 3 now in the bottommost position.

Note that, because the finger 13 engages with tube 3 it cannot fully extend and no signal is sent from the detector 16 to the PLC board 60. If there were no tube in the magazine 7 to stop the extension of the finger 13, a signal would be sent by the sensor 16 to the PLC board 60 indicating that the magazine 7 is empty.

The tube drive cylinder 37 is then extended driving the tube 3 in the bottommost position forward, past the guide 9, and into contact with the end of the track 4. The pusher 41 is then advanced into the tube 3 to drive components 5 along the track to the pick point 62.

Note that cylinder 37 will not reach its full extension if the tube 3 contacts the end of the track 4 and therefore, sensor 36 will not generate a signal to the PLC board 60. If there were no tube present between the tube drive cylinder 37 and the track 4, the sensor 36 would send a signal to the PLC board 60 indicating that the feeder 1 is empty.

The above embodiments are illustrative of the present invention. While these are presently considered the most practical and preferred embodiments, it is to be understood that the invention is not limited by this disclosure. This invention is intended to cover various modifications and equivalent arrangements included within the spirit and scope of the invention, as will be apparent to a person of ordinary skill in the art.

We claim:

1. A component feeder for feeding components from a plurality of vertically stacked component tubes to an automatic placement machine, the feeder comprising:
a first vertical guide and a second vertical guide, first and second vertical guides spaced apart a distance approximately equal to the length of the component tubes, the component tubes, with the exception of the bottommost tube, adapted to be disposed and confined therebetween;
a track positioned between a first one of the vertical guides and the placement machine adapted for conveying the components; and
means for displacing the bottommost tube along its longitudinal axis, past the first one of the vertical guides, and into engagement with the track.

2. The component feeder according to claim 1, further comprising pusher means for applying a force to advance the components along the longitudinal axis of the bottommost tube and along the track.

3. The component feeder according to claim 2, wherein the pusher means includes a pusher, a drive ribbon connected with the pusher, a drive roller, and a spool, the drive ribbon being wound on the spool and driven by the drive roller.

4. The component feeder according to claim 3, further comprising a programmable controller, the controller adapted to control the means for displacement to selectively engage the bottommost tube with the track and to control the pusher means to selectively advance the components.

5. The component feeder according to claim 4, wherein the pusher means further comprises an encoder connected with the spool, the encoder providing a signal to the controller indicating a position of the pusher.

6. The component feeder according to claim 1, wherein the means for displacing includes a pneumatic cylinder adapted to apply a force to a rear end of the bottommost tube.

7. The component feeder according to claim 6, wherein the means for displacing further comprises means for detecting whether the bottommost tube is in engagement with the track.

8. The component feeder according to claim 7, wherein the means for detecting is a sensor adapted to sense a full extension of the cylinder.

9. The component feeder according to claim 1, further comprising a front escapement and a rear escapement, wherein each of the front and rear escapements are moveable from an engaged position adapted to support a next tube immediately above the bottommost tube and a disengaged position, wherein the next tube is not supported.

10. The component feeder according to claim 9, wherein means for displacing further comprises:
a supporting ledge adapted to support the rear end of the bottommost tube;
a first drive cylinder for driving the supporting ledge and the rear escapement; and
a second drive cylinder for driving the first drive cylinder, wherein extending the second drive cylinder moves the rear escapement to the engaged position and retracting the second drive cylinder moves the rear escapement to the disengaged position and wherein extending the first drive cylinder when the second drive cylinder is extended displaces the bottommost tube into engagement with the track.

11. The feeder according to claim 1, further comprising adjustment means for adjusting the distance between the first and second vertical guides

12. A component feeder for feeding components from a plurality of tubes to a pick point of an automatic placement machine, the tubes being stacked in a one-above-another arrangement, the feeder comprising:
a magazine adapted to hold the stacked plurality of tubes;
a front magazine guide forming an inside surface of the magazine;
a component track, the pick point being at a front end of the track, the track being aligned with a bottommost tube of the stacked plurality of tubes, and the rear end of the track being located forward of the front guide;
a drive mechanism adapted to drive the bottommost tube along its longitudinal axis past the front magazine guide into engagement with the track;
a pusher adapted to advance the components along the track; and
a pusher drive connected with the pusher and adapted to drive the pusher.

13. The feeder according to claim 12, further comprising:
a front escapement finger extending through the front magazine guide and moveable from an engaged position engaging a front end of a next tube stacked immediately above the bottommost tube and a disengaged position wherein the next tube is disengaged; and
a rear escapement located at a rear end of the next tube and moveable from an engaged position wherein the rear end of the next tube is engaged and a disengaged position wherein the next tube is disengaged.

14. The feeder according to claim 13 wherein the drive mechanism comprises:
a supporting ledge;
a first drive cylinder for driving the supporting ledge;
a second drive cylinder for driving the first drive cylinder, wherein extending the second drive cylinder moves the rear escapement to the engaged position and retracting the second drive cylinder moves the rear escapement to the disengaged position and wherein extending the first drive cylinder when the second drive cylinder is extended drives the front end of the bottommost tube into engagement with the track.

15. The feeder according to claim 14, wherein the tube support comprises a fork and a third drive cylinder connected with the fork, wherein when the third drive cylinder is extended the fork supports a bottom surface of the bottommost tube and wherein when the third drive cylinder is in its retracted position the fork is positioned away from the bottom surface of the bottommost tube and does not support the bottommost tube.

16. The feeder according to claim 15, wherein the fork further comprises one or more tines, wherein ends of those tines contact the bottommost tube when the third drive cylinder is extended and wherein the component track further comprises mating slots, the mating slots positioned to receive the tines when the third drive cylinder is in the retracted position.

17. The feeder according to claim 16, wherein the pusher drive comprises a drive roller, an encoder, and a ribbon and wherein the pusher is connected with the ribbon, the pusher is driven by driving the ribbon with the drive roller, and a longitudinal position of the pusher is monitored by the encoder.

18. A component feeder for feeding components from a plurality of tubes to a pick point of an automatic placement machine, the tubes being stacked in a one-above-another arrangement, the feeder comprising:
vertical side supports along the sides of the stacked plurality of tubes, separation between the side supports being adjustable to accommodate tubes of varying widths;
a rear magazine guide disposed adjacent rear ends of the stacked plurality of tubes;
a front magazine guide disposed adjacent front ends of the stacked plurality of tubes, except for the bottommost tube, separation of the front and rear magazine guides being adjustable to accommodate tubes of varying lengths;
a component track, the pick point being at a front end of the track, the track being aligned with the bottommost tube of the stacked plurality of tubes, and a rear end of the track being located forward of the front guide;
a pneumatic cylinder adapted to apply a force to a rear end of the bottommost tube to drive the bottommost tube along its longitudinal axis, wherein the front end of the bottommost tube is driven past the front magazine guide and into engagement with the track;
a sensor adapted to detect when the cylinder is fully extended;
a pusher adapted to advance components along the track;
a pusher drive connected with the pusher and adapted to drive the pusher, wherein the pusher drive includes a drive ribbon connected with the pusher and wound on a spool, a drive roller in contact with the ribbon, and an encoder connected with the spool and adapted to generate a signal indicating a rotational position of the spool, the drive ribbon being driven by the drive roller; and
a programmable controller connected with the cylinder, the sensor, and the pusher drive, wherein the controller is adapted to actuate the cylinder to selectively engage the tube with the track, to determine that the bottommost cylinder is engaged with the track by monitoring the sensor to determine that the cylinder is not fully extended, and to selectively advance the pusher.
